(19) United States
(12) Patent Application Publication
(10) Pub. No.: US 2020/0017138 A1
(43) Pub. Date: Jan. 16, 2020

(54) STEERING SYSTEM

(71) Applicant: Miba Sinter Austria GmbH, Laakirchen (AT)

(72) Inventor: Stefan KIRCHWEGER, Gschwandt (AT)

(73) Assignee: Miba Sinter Austria GmbH, Laakirchen (AT)

(21) Appl. No.: 16/442,745

(22) Filed: Jun. 17, 2019

(30) Foreign Application Priority Data
Jul. 16, 2018 (AT) A 50610/2018

(51) Int. Cl. B62D 5/04; F16H 7/02; F16H 55/36

(52) U.S. Cl. CPC B62D 5/0424; F16H 55/36; F16H 7/02

(57) ABSTRACT

The invention relates to a steering system (1) comprising a motor (2) with a first belt pulley (5) and a recirculating ball drive (6) with a second belt pulley (7), wherein the first and the second belt pulleys (5, 7) are connected to one another via a belt. The first and/or second belt pulley (5, 7) comprise(s) an outer ring (12), an inner ring (13) and an intermediate ring (14), wherein the outer ring (12) preferably comprises an external toothing (1), the intermediate ring (14) is arranged between the outer ring (12) and the inner ring (13) in radial direction and connected to these, and the intermediate ring (14) at least partially consists of a rubbery-elastic material.

The invention relates to a steering system comprising a motor with a first belt pulley and a recirculating ball drive with a second belt pulley, wherein the first and the second belt pulleys are connected to one another via a belt.

As is known, in servo steerings, an auxiliary drive is used for reducing the force to be applied for steering. In so-called EPS steering systems (Electric Power Steering systems), this is an electric drive. There are different types of EPS steering systems, namely a CEPS system, in which the servo unit is positioned in the steering train and transmits the rotational movement via a worm gear, a PEPS system, in which the servo unit is arranged on the steering gear pinion and drives a second, separate pinion shaft via a worm gear, and an REPS, in which the servo unit is positioned in parallel to or concentrically around the gear rack and the rotational movement is transmitted via a belt and a recirculating ball drive (also referred to as recirculating ball screw drive). The present invention relates inter alia to the last-mentioned REPS system.

Such an EPS steering system is for example known from DE 10 2016 124 393 A1, which describes a steering system comprising a motor, a steered shaft with a thread groove, the steered shaft being configured to reciprocate in an axial direction of the steered shaft, a ball screw mechanism including a cylindrical nut screwed to the thread groove via a plurality of balls, the ball screw mechanism being configured to provide an axial force to the steered shaft in accordance with rotation of the nut, a speed reducer including a driven belt pulley fixed to an outer peripheral surface of the nut disposed inward of the driven belt pulley, a driving belt pulley fixed to a rotary shaft of the motor so as to be rotatable together with the rotary shaft, and a belt wound around the driven belt pulley and the driving belt pulley; a belt tension adjusting mechanism to adjust a tension of the belt, and a housing which houses the steered shaft, the ball screw mechanism, the speed reducer, and the belt tension adjusting mechanism, wherein the housing includes a first housing member and a second housing member aligned in the axial direction, portions of the first and second housing members mating with each other and protruding in a direction perpendicular to the axial direction constitute a speed reducer casing which houses a portion of the speed reducer, the speed reducer casing is provided in its outer wall with a through hole passing through the outer wall in the axial direction, the belt tension adjusting mechanism includes a tension adjustment shaft, and a tension pulley rotatably disposed around an outer peripheral surface of the tension adjustment shaft, the tension pulley being configured to abut against the belt, the tension adjustment shaft includes a first end protruding out of the housing through the through hole, a second end housed in the housing, the second end being coaxial with the first end, and an eccentric cylindrical portion eccentric relative to a central axis of the first and second ends, the eccentric cylindrical portion being disposed between the first and second ends, and the tension adjustment shaft being configured to rotate around the central axis of the first and second ends.

Transverse forces, inter alia caused by axial loads, are consumed by support discs or spring assemblies inserted between the EPS housing and the bearing for the recirculating ball drive in REPS steering systems. The recirculating ball drive including nut, toothed lock washer and bearing may “tilt” with respect to the electric motor, effecting the drive, mounted fixedly in the housing. Hence, a tendency of the timing belt to rest against and/or run against either the collar of the large side of the recirculating ball drive or that of the smaller belt pulley. Associated with this, the belt must correspondingly elongate on the opposite edge. In the course of this, vibrations occur on the belt. In further consequence, this results in damage to the steering system.

The underlying object of the present invention is to improve a steering system of the aforementioned type.

In the steering system, this object is achieved by the first and/or the second belt pulley comprising an outer ring, an inner ring and an intermediate ring, wherein the outer ring preferably comprises an external toothing, the intermediate ring is arranged between the outer ring and the inner ring in radial direction and connected to these, and the intermediate ring at least partially consists of a rubbery-elastic material.

By means of this steering system, decoupling of the recirculating ball drive from the belt drive is achieved. Thus, axial forces and/or bracing no longer affect the belt running. The connection of the motor to the recirculating ball drive may thus be improved. Consequently, the aforementioned support discs and/or spring assemblies in the EPS steering system can be omitted, which allows for easier assembly of the EPS steering system. Moreover, an improvement of the NHV (noise, vibration, harshness) behavior of the steering system may also be achieved thereby. Moreover, by means of the improvement of the accuracy of movement and/or running smoothness of the timing belt, the risk of wearing of the timing belt can be reduced.

According to an embodiment variant of the steering system, it is preferably provided for that the intermediate ring is arranged in radial direction between a bearing seating surface and a contact surface of the second belt pulley on a recirculating ball drive nut. This allows for the formation of a force fit between the belt pulley and the recirculating ball drive nut, whereby the (powder-metallurgical) manufacture of the belt pulley can be facilitated by the omission of positive connections, catches, etc. Optionally, the required maximum tolerances may also be achieved without a turning operation, as the required superposition in combination with process-specific deviations in diameter and roundness comprises a tendentially lower influence on the deformation of toothed lock washer and bearing, than in a conventional force fit design.

According to another embodiment variant of the steering system, it may be provided for that edges of the inner ring in the connection area between the inner ring and the intermediate ring and/or edges in the connection area between the outer ring and the intermediate ring are provided with curvatures. The advantage of this is that hence, the continuous resilience of the belt pulley can be improved. By the formation of curved edges on the inner and/or outer ring, the punctual overload of the connection area on the edges can be prevented. Hence, the occurring continuously alternating compressive and tensile loads of the intermediate ring can better be consumed by it. Moreover, the notch effect of the edges can also be prevented. In addition to this, by means of the curvatures, the surfaces available for the connection of the inner and outer ring with the intermediate ring are enlarged, whereby the continuous resilience may also be improved. By means of the curvatures of the edges it is also achieved that in a flush design of the connection element with the axial end faces of the two ring elements, the intermediate ring radially encompasses the inner ring and/or the outer ring in the connection area, whereby compressive and tensile loads of the cogwheel in axial direction may also be consumed better. As a side effect, the curved edges have the advantage that the inner ring and the outer ring may be demolded better if these are manufactured from sintered materials.

According to a further embodiment variant of the steering system, it may be provided for that the intermediate ring extends to protrude from the inner ring and/or the outer ring in axial direction and to partially cover the inner ring and/or the outer ring in radial direction. Thereby, a further improvement of the connection of the intermediate ring with the inner and/or outer ring may be achieved, whereby in further consequence, the continuous stability of this connection may be further improved.

For the same reasons, it may further be provided for that the inner ring has a recess on at least one axial end face and/or the outer ring has a recess on at least one axial end face and that the intermediate ring engages with the recess or the recesses. For the aforementioned reasons, edges of the recesses in the axial end faces according to an embodiment variant of the steering system are also provided with curvatures.

Alternatively or additionally to this, it may also be provided for improving the connection between the intermediate ring and the inner ring and/or the outer ring that the inner ring has a recess on at least one radial face and/or the outer ring has a recess on at least one radial face and that the intermediate ring engages with the recess or the recesses, wherein, in turn, according to an embodiment variant of the steering system it is preferred in this regard for edges of the recesses to also be provided with a rounding in the radial faces.

Preferably, the intermediate ring is vulcanized onto the inner ring and/or the outer ring or grouted with the inner ring and/or the outer ring, as hence a relatively high connection stability between the components may easily be achieved. Moreover, hence, the formation of the curvatures in the area of the curved edges in the connection element may be effected in a more complete and fitting manner.

For the purpose of better understanding of the invention, it will be elucidated in more detail by means of the figures below.

These respectively show in a simplified schematic representation:

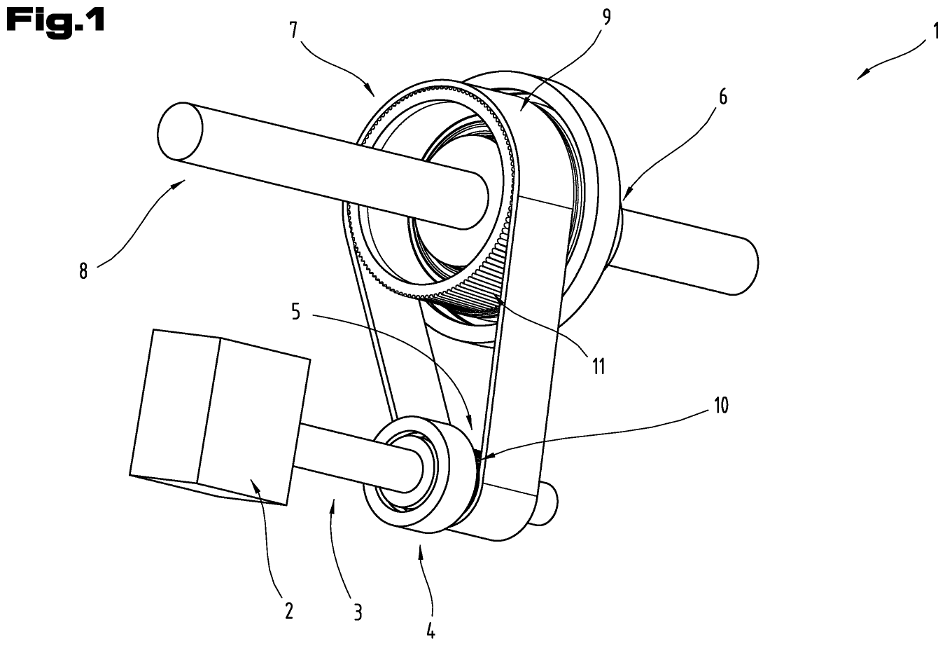

FIG. 1 a cutout from a steering system in an oblique view;

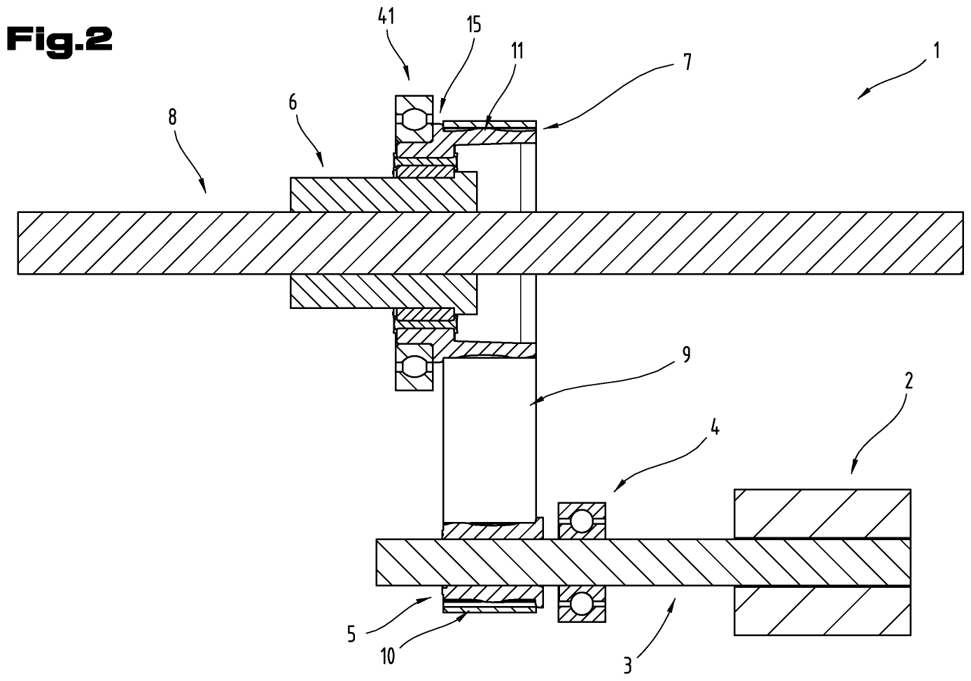

FIG. 2 the steering system according to FIG. 1 in a sectional side view;

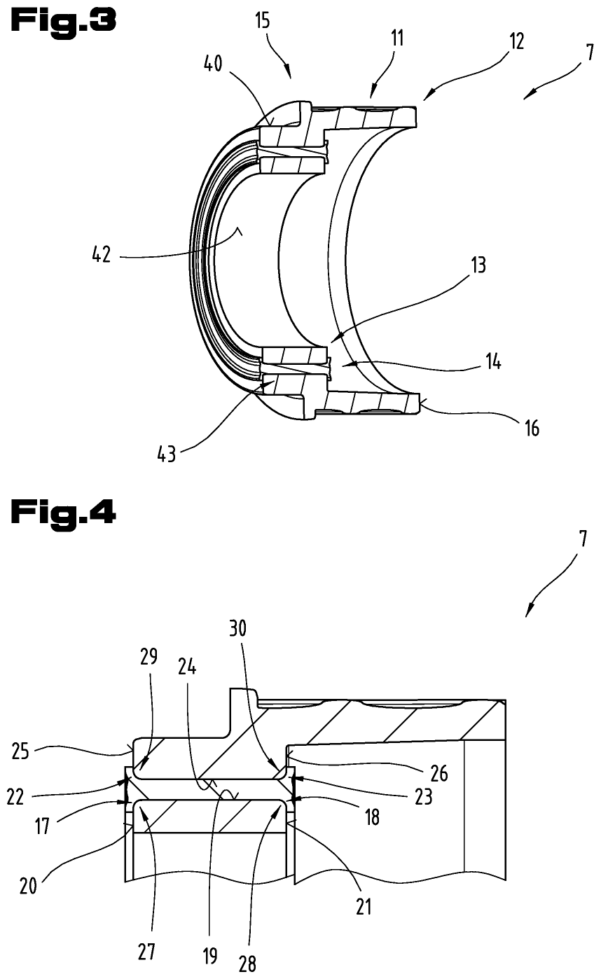

FIG. 3 a section through a belt pulley in an oblique view;

FIG. 4 a cutout from a further embodiment variant of the belt pulley in cross-section;

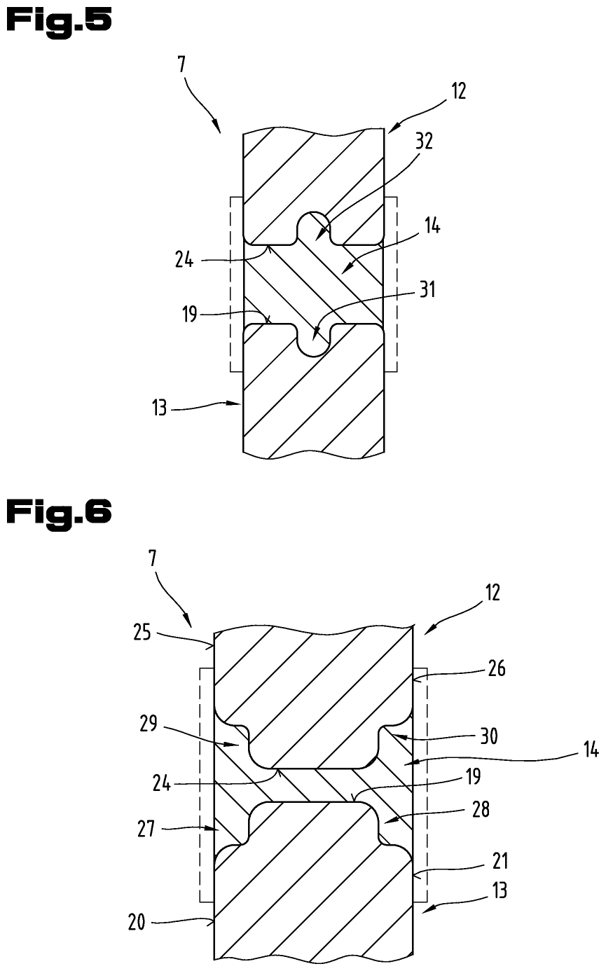

FIG. 5 a cutout from another embodiment variant of the belt pulley in cross-section;

FIG. 6 a cutout from a further embodiment variant of the belt pulley in cross-section;

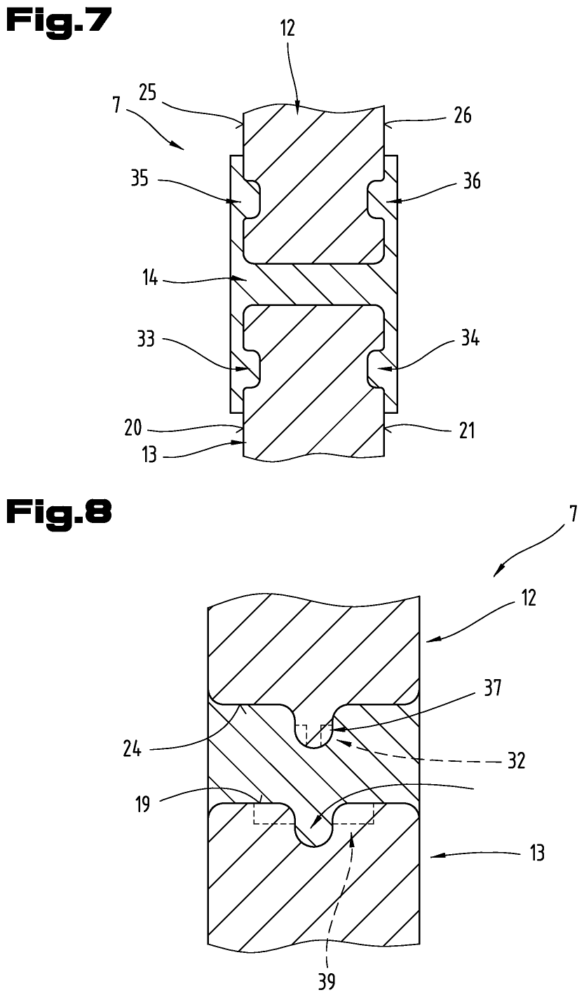

FIG. 7 a cutout from a further embodiment variant of the belt pulley in cross-section;

FIG. 8 a cutout from a further embodiment variant of the belt pulley in cross-section;

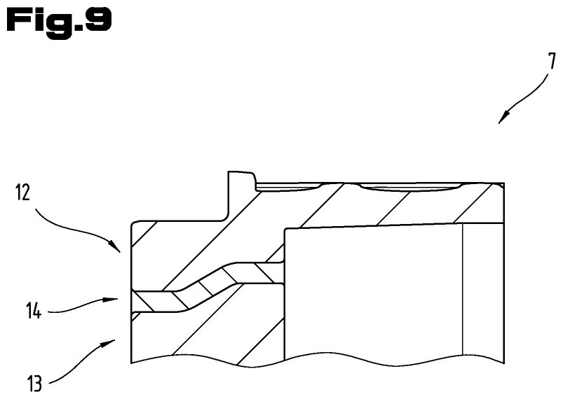

FIG. 9 a cutout from a further embodiment variant of the belt pulley in cross-section.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

FIGS. 1 and 2 show a cutout from a steering system 1, in particular an EPS steering system 1 in an oblique view and in a sectional side view, respectively. These two figures merely show the details relevant to the description of the invention, as such steering systems are already known from prior art and described in detail therein. Thus, with respect to further details of these steering systems, reference is made to relevant prior art.

The steering system 1 comprises a motor 2, in particular being an electric motor, merely adumbrated in the figures. The motor 2 comprises a shaft 3, which may be mounted with at least one bearing 4. A first belt pulley 5 (which can also be referred to as pulley), the so-called small belt pulley 5, is arranged on this shaft 3 and connected to it in a torque-proof manner. Thus, the first belt pulley 5 is the driving belt pulley 5 of the steering system 1.

The bearing 4 is shown as a rolling bearing, in particular as a ball bearing. However, the bearing 4 may also be a sliding bearing.

The torque-proof connection between the first belt pulley 5 and the shaft 3 can be effected by known methods and can be formed to be positive locking and/or force-fit and/or materially bonded.

The steering system 1 further comprises a recirculating ball drive 6 with a second belt pulley 7 (which can also be referred to as pulled), the so-called large belt pulley 7, merely adumbrated in FIGS. 1 and 2.

The second belt pulley 7 is connected to the recirculating ball drive nut of the recirculating ball drive 6 in a torque-proof manner. The torque-proof connection between the second belt pulley 7 and the recirculating ball drive nut can be effected by known methods and can be formed to be positive locking and/or force-fit and/or materially bonded. In particular, a force fit may be formed between the second belt pulley 7 and the recirculating ball drive nut.

The recirculating ball drive 6 is arranged on a second shaft 8 (of the ball screw spindle).

The first belt pulley 5 is coupled, i.e. connected, to the second belt pulley 7 via a belt. The belt is preferably designed as a timing belt 9. Accordingly, the first belt pulley 5 and the second belt pulley 7 preferably also comprise an external toothing 9 and/or an external toothing 10.

The second belt pulley 7 is driven by the first belt pulley 5 via the belt. Thus, the second belt pulley 7 is the driven belt pulley 7 of the steering system 1.

The shaft 3 rotating through the motor 2 in a steering operation and thus the rotating first belt pulley 5 via the belt causes the second belt pulley 7 to also enter into a rotational movement. This rotational movement is translated into a linear movement of the shaft 8 by the recirculating ball drive 6, whereby the shaft reciprocates and thus supports the steerer with the steering movement, as is per se known.

The second belt pulley 7 can better be seen from FIG. 3 showing a section through the second belt pulley 7 in an oblique view.

The second belt pulley 7 comprises and/or consists of an outer ring 12, an inner ring 13 and an intermediate ring 14.

It should be noted that the geometry of the outer ring 12, of the inner ring 13 and of the intermediate ring 14 shown in FIG. 3 is preferred, however, is not to be understood in a limiting manner.

The outer ring 12 and the inner ring 13 are preferably manufactured from a metallic material, in particular from steel. Particularly preferred, the outer ring 12 and the inner ring 13 are manufactured according to a powder-metallurgical method, preferably from a sintered steel powder. However, the outer ring 12 and/or the inner ring 13 may also consist of another (metallic) material, wherein the outer ring 12 (per se) and/or the inner ring 13 (per se) may also consist of at least two different metallic materials.

The intermediate ring 14 at least partially consists of a rubbery-elastic material, for example of an (X)NBR ((carboxylated) acrylonitrile butadiene rubber), HNBR (hydrogenated nitrile rubber), a silicone rubber (VMQ), NR (natural rubber), EPDM (ethylene propylene diene monomer rubber), CR (polychloroprene), SBR (styrene butadiene rubber) etc., wherein here again, mixtures of materials may be used.

“At least partially” means that for example stiffening elements, such as fibers and/or threads, for example of metal, plastic materials, natural fibers etc., or bars, etc. may be incorporated in the intermediate ring 14. However, the intermediate ring 14 preferably solely consists of a rubbery-elastic material.

The outer ring 12 is arranged radially outside and the inner ring 13 radially inside, i.e. below the outer ring 12 in radial direction, and in particular concentrically to the outer ring 12. The intermediate ring 14 is arranged between the outer ring 12 and the intermediate ring 13 in radial direction.

The outer ring 12 carries the aforementioned external toothing 11 on an outer surface, i.e. on a lateral surface. It may extend across the entire axial length of the second belt pulley 7. However, preferably, a flange 15 projecting from the radially outer lateral surface is formed, such that the external toothing 11 particularly extends from a first axial end face 16 to said flange 15. However, the flange 15 may also be arranged on the outer ring 12 as a separate component and be connected to it.

The outer ring 12 is connected to the inner ring 13 via the intermediate ring 14. For effecting a connection, the intermediate ring 14 may be preformed and then be connected to the outer ring 12 and the inner ring 13, for example using a bonding agent, such as for example an adhesive. However, in the preferred embodiment variant of the steering system 1, the intermediate ring 14 is vulcanized onto the inner ring 13 and/or the outer ring 12 in a corresponding form, in particular heat-vulcanized or grouted with the inner ring 12 and/or the outer ring 13 (in particular according to a compression molding method). Optionally, a primer or bonding agent may be applied onto the surfaces which are connected to the intermediate ring 14 beforehand in the course of this.

The connection of the intermediate ring 14 with the outer ring 12 and/or the inner ring 13 can also be effected by means of a transfer molding method, an injection molding method or by means of an injection-compression method.

In principle, transitions from axial into radial faces of the outer ring 12 and/or the inner ring 12 in the area of the intermediate ring 14 may be designed to be sharp-edged. However, according to an embodiment variant of the steering system 1 (FIG. 1), it may be provided for that axially outer edges 17, 18, i.e. the edges 17, 18 in the transition area from a radial face 19 to axial end faces 20, 21 of the inner ring 13 and/or axial outer edges 22, 23, i.e. the edges 22, 23 in the transition area from a radial face 24 to axial end faces 25, 26 of the outer ring 12 are designed to be curved for achieving the aforementioned effects, i.e. provided with a curvature 27 to 30, as is shown in FIG. 4, which shows cutouts from an embodiment variant of the second belt pulley 7. Instead of the curvatures, sintered chamfers may also be provided for.

It should be noted by way of explanation that in the represented embodiment variant of the second belt pulley 7, the radial face 19 is the radially outer lateral surface of the inner ring 13 and the radial face 24 is the radially inner lateral surface of the outer ring 12, i.e. those faces of the outer and inner rings 12, 13 which face towards one another in the assembled state of the second belt pulley 7.

The radius of the curvatures 27 to 30 is preferably selected from a range of 0.1 mm to 2 mm, in particular from a range of 0.4 mm to 1.5 mm.

It is possible that the radii of all curvatures 27 to 30 are equal. However, it is also possible that at least one of the curvatures 27 to 30 comprises a radius differing from that of the remaining curvatures 27 to 30. For example, the two curvatures 27, 28 of the inner ring 13 may have a larger radius that the two curvatures 29, 30 of the outer ring 12. However, it is also possible that the curvatures 27 and 29 comprise a larger radius in the area of an axial side of the second belt pulley 7, i.e. for example in the area of the axial end faces 20, 25, i.e. the curvatures 28 and 30 of the second axial side of the second belt pulley 7, i.e. for example in the area of the axial end faces 21, 26. With these embodiment variants, i.e. with the different designs of the curvatures 27 to 30, most diverse load cases of the second belt pulley 7 in the axial and radial directions may better be taken into consideration.

In the simplest case, the curvatures 27 to 30 are designed as pitch circles, for example quarter circles, or elliptically. However, other embodiments of the curvatures 27 to 30 are also possible.

As can particularly also be seen from FIG. 4, according to a further embodiment variant of the steering system 1 (FIG. 1), the intermediate ring 14 may extend to protrude from the outer ring 12 and the inner ring 13 in axial direction and to partially cover the outer ring 12 and/or the inner ring 13 in radial direction. The intermediate ring 14 can thus in particular comprise an at least approximately H-shaped and/or an H-shaped cross-section.

However, it is also possible that the intermediate ring 14 designed to be flush with the axial end faces 20, 21 of the inner ring 13 and/or flush with the axial end faces 25, 27 of the outer ring 12.

It is also possible that the intermediate ring 14 only in the area of the axial end faces 20, 25 or only in the area of the axial end faces 21, 26 of the inner ring 13 and outer ring 12 extends to protrude from these surfaces in axial direction and to partially cover these in radial direction.

Details of further independent embodiment variants of the steering system 1 (FIG. 1) are shown in FIGS. 5 to 9, wherein again, equal reference numbers and/or component designations are used for equal parts as in FIGS. 1 through 4 before. In order to avoid unnecessary repetitions, it is pointed to/reference is made to the detailed description regarding these FIGS. 1 to 4.

As can be seen from FIG. 5, according to an embodiment variant of the second belt pulley 7, it may be provided for that the inner ring 13 comprises at least one recess 31 on the radial face 19 and/or that the outer ring 12 comprises at least one recess 32 on the radial face 24, wherein the intermediate ring 14 engages with the recess 30 or 31 or with the recesses 30, 31.

The recess 30 or 31 or the recesses 30, 31 may merely be arranged in discrete areas across the outer circumference of the inner ring 13 and the inner circumference of the outer ring 12, wherein respectively, several of the discrete recesses 30, 31 may of course be provided, in particular distributed uniformly across the outer circumference of the inner ring 13 and the inner circumference of the outer ring 12. However, the recesses 30, 31 can also be designed as annular grooves.

Moreover, it is possible that merely one annular-groove-shaped recess 30 and/or one annular-groove-shaped recess 31 is/are provided. However, it is also possible to provide several annular-groove-shaped recesses 30 and/or several annular-groove-shaped recesses 31 next to one another in axial direction and separate from one another in the radial faces 19 and/or 24. For example, the radial face 19 or 24 can be designed to be at least approximately wave-shaped and/or the radial faces 19, 24 can be designed to be at least approximately wave-shaped and/or the radial face 19 or 24 or the radial faces 19, 24 can be designed in the manner of a toothing with several annular-groove-shaped recesses 30 and/or 31 arranged next to one another.

Moreover, there is the possibility of a combination of at least one discrete recess 30 with at least one annular-groove-shaped recess 30 in the radial face 19 and/or a discrete recess 31 with at least one annular-groove-shaped recess 31 in the radial face 24.

Preferably, for the aforementioned reasons, the edges of the recesses 30, 31 in the radial faces 19, 24 are also provided with curvatures, as is represented in FIG. 5.

As represented in FIG. 6, there further is the possibility that the transition areas between the radial face 19 and the axial end faces 20, 21 of the inner ring 13 and/or the transition areas between the radial face 24 and the axial end faces 25, 26 of the outer ring 12 is/are designed to be stepped. In particular, all of these transition areas can be designed to be staged. In other words, the curvatures 27 to 30 of the edges 17, 18 (FIG. 2) of the inner ring 13 and/or the edges 22, 23 (FIG. 2) of the outer ring 12 can respectively be provided with curvatures 27, 28 and/or 29, 30, which comprise non-consistent curvature radii.

It is thus possible that at least one of the curvatures 27 to 30, for example two or all four, comprise a first positive radius area (curvature area pointing outwards), an adjacent negative radius area (curvature pointing inwards) and adjacent thereto a second positive radius area (curvature area pointing outwards).

Thus, at least one of the curvatures 27 to 30 can be provided with an at least approximately wave-shaped profile.

These designs can also serve to improve the connection between the intermediate ring 14 and the inner ring 13 as well as the outer ring 12.

Furthermore, more than one stepping can be provided on the inner ring 13 and/or on the outer ring 12 in the area of at least one of the curvatures 27 to 30, for example two steppings or three steppings, etc.

It may be provided for, both in the embodiment variant of the second belt pulley 7 according to FIG. 5 and in the embodiment variant of the second belt pulley 7 according to FIG. 6, that the intermediate ring 14 is flush with the inner ring 13 and/or the outer ring 12 or is designed to protrude from these in axial direction and to partially cover these in radial direction (shown in dashed lines in FIGS. 5 and 6), as was elucidated above.

FIG. 7 shows a cutout from a further embodiment variant of the second belt pulley 7. In this regard, it may be provided for that the inner ring 13 comprises at least one recess 33, 34 on at least one of the axial end faces 20, 21 and/or the outer ring 12 comprises a recess 35, 36 on at least one of the axial end faces 25, 26, wherein the intermediate ring 14 engages with at least one of the or with the recesses 33 to 36.

The recesses 33 to 36 may merely be arranged in discrete areas in the axial end faces 20, 21 of the inner ring 13 and the axial end faces 25, 26 of the outer ring 12, wherein respectively, several of the discrete recesses 33 to 36 may of course be provided, in particular being distributed uniformly. In another embodiment variant, the recesses 33 to 36 are designed as annular grooves.

Moreover, it is possible that merely one annular-groove-shaped recess 33, 34 and/or one annular-groove-shaped recess 35, 36 is/are provided. However, it is also possible to provide several annular-groove-shaped recesses 33, 34 and/or several annular-groove-shaped recesses 35, 36 above one another in radial direction and separate from one another in the axial end faces 20, 21, 25, 26. For example, at least one of the axial end faces 20, 21, 25, 26 and/or the axial end faces 20, 21, 25, 26 can be designed to be approximately wave-shaped and/or the axial end face 20 and/or 21 and/or 25 and/or 26 or the axial end faces 20, 21, 25, 26 can at least in the area of the intermediate ring 14 be designed in the manner of a toothing with several annular-groove-shaped recesses 33 and/or 34 and/or 35 and/or 36 arranged next to one another.

Moreover, there is the possibility of a combination of at least one discrete recess 33 to 36 with at least one annular-groove-shaped recess 33 to 36 in the axial end faces 20, 21, 25, 26.

Preferably, for the aforementioned reasons, according to a further embodiment variant the edges of the recesses 33 to 36 in the axial end faces 20, 21, 25, 26 are also provided with curvatures, as is represented in FIG. 7.

All curvature radii of the edges of the individual embodiment variants of the second belt pulley 7 can be selected from the aforementioned ranges.

Moreover, for improving the formation of connections, it is possible that the at least one of the or the radial faces 19, 24 and/or at least one of the or the axial end faces 20, 21, 25, 26 are roughened at least in the area of the connection with the intermediate ring 14, for example by means of (sand)blasting or by means of grinding, etc.

However, it is also advantageous if at least in the connection areas, open-pored sintered components are used for the inner ring 13 and/or the outer ring 12, as thereby, likewise, a type of interlocking between the intermediate ring 14 and the inner ring 13 and/or the outer ring 12 can be achieved.

It may further be advantageous if at least the faces of the inner ring 13 and/or the outer ring 12 are subjected to a plasma pretreatment and/or plasma activation and/or a steam treatment, with optionally subsequent blasting of the surface with a blasting means, for example balls, in the area of the connection with the intermediate ring 14.

It is to be illustrated by FIG. 8 that combinations of the embodiment variants of the second belt pulley 7 are also possible. In this regard, the inner ring 13 comprises the at least one recess 31, analogously to the embodiment variant according to FIG. 5. Thus, all of the above explanations regarding the inner ring 13 of the embodiment variant according to FIG. 5 can be transferred to the embodiment variant according to FIG. 8 and reference is explicitly made thereto.

The outer ring 12 is, in contrast, designed with at least one projection 31, alike the embodiment variant of the second belt pulley 7 according to FIG. 6. This projection 37 extends to project from the radial inner face 24 of the outer ring 12 in the direction towards the inner ring 13. In particular, the at least one projection 37 is formed as an annular web, which, as the annular-groove-shaped recess 31 in this and/or the other embodiment variants of the second belt pulley 7, is formed to extend across the entire circumference. In this regard, the circumference refers to the face 24 of the outer ring 12 in view of the at least one projection 37 and to the face 19 in view of the at least one recess 31.

It is also possible that more than one, in particular annular-web-shaped projection 37 is provided on the radially inner face 24 of the outer ring 12. For example, two, three, four, etc. projections 37, which are arranged and/or formed next to one another and spaced from one another in axial direction of the second belt pulley 7.

Moreover, it is possible that the projection 37 or at least one of the several projections 37 are designed with at least one stepping 38—viewed in radial direction —, as is adumbrated by dashed lines in FIG. 8. Likewise, alternatively or additionally thereto, the at least one recess 31 of the first radially inner ring element 2 can be designed with a stepping 39, as is also represented in dashed lines in FIG. 8. The latter can also be provided for in all further embodiment variants of the second belt pulley 7.

All edges of the at least one projection 37 can be provided with curvatures, wherein the curvature radii can be selected from the aforementioned range.

By the arrangement of several projections 37 located next to one another in axial direction, in turn, an at least approximately wave-shaped or a toothing-shaped design of the radially inner face 24 can be achieved, as was already elucidated above.

In the embodiment variant of the second belt pulley 7 represented in FIG. 8, the projection 37 as viewed in radial direction is located precisely above the at least one recess 31. However, it is also possible that the at least one recess 37 is arranged to be offset to the at least one recess 31 in axial direction. In this case, it may be advantageous if several projections 37 are arranged, the at least one recess 31 being arranged between the projections 37 as viewed in axial direction.

Of course, in the context of the invention, the reverse design of the second belt pulley 7, in which the at least one projection 37 is arranged or formed on the inner ring 13 and the at least one recess 31 is arranged or formed on the outer ring 12, is also possible. The above statements regarding FIG. 8 are also applicable to this reverse embodiment variant in correspondingly adapted manner.

As FIG. 9 shows, the intermediate ring 14 can at least in certain areas comprise a conical course (in the axial direction). Accordingly, the outer ring 12 and the inner ring 13 also comprise an at least partially conical course of the surfaces abutting on the intermediate ring 14.

Alternatively or additionally, it is possible that the first belt pulley 5 is designed with an inner ring, an outer ring and an intermediate ring. Thus, the statements regarding the second belt pulley 7 can in this case be transferred to the first belt pulley 5.

According to a further embodiment variant of the second belt pulley 7, which can best be seen from FIG. 3, it may be provided for that the intermediate ring 14 is arranged between a bearing seating surface 40 for a bearing 41 in radial direction (FIG. 2) and a contact surface 42 of the second belt pulley 7 is arranged on the recirculating ball drive nut. For this purpose, the outer ring 12 can comprise a radial projection 43, which is in particular integrally formed therewith, and extends in the direction towards the inner ring 12. Preferably, the axial length of the radial projection 43 is equally large to the axial length of the inner ring 12 (in the same direction), as can be seen from FIG. 3.

It is moreover preferred that this radial projection 43 is formed to start from the second axial end face 25 of the outer ring 12, as is also represented in FIG. 3. However, the radial projection 43 can also be arranged at another position of the outer ring 12, for example centrally.

The radial projection 43 can have a larger axial length than the bearing seating surface 40 as viewed in the same direction. Thus, the flange 15 (FIG. 2) can also be arranged above the radial projection 43 in radial direction.

The bearing 41 can again be designed as a rolling bearing, in particular as a ball bearing, or as a sliding bearing. Via this bearing 41, the rotatable mounting of the second belt pulley 7 with the recirculating ball drive nut in a housing of the recirculating ball drive 6 (FIG. 2) can be enabled.

The second belt pulley 7 can be arranged on the recirculating ball drive nut acentrically (as viewed in axial direction) (as can be seen from FIG. 2), for example by means of a force fit. However, it can also be arranged centrically on the recirculating ball drive nut.

On demand, the steering system 1 can also comprise a speed reducer for reducing the rotational frequency supplied by the motor.

Besides the use of the belt pulley 7 in a steering system, it can also be used in other motor vehicle applications, such as generally in an automotive belt drive, in a timing drive, in a drive for an ancillary unit. Moreover, applications in automation engineering, such as in a robot, or generally in belt and chain drives, are also possible, while the toothing of the belt pulley 7 can be designed differently for chain drives.

The exemplary embodiments show possible embodiment variants of the steering system 1, while it should be noted at this point that combinations of the individual embodiment variants are also possible.

Finally, as a matter of form, it should be noted that for ease of understanding of the structure of the steering system 1, the steering system 1 and/or elements thereof are not obligatorily depicted to scale.

List of reference numbers

| | |
|---|---|
| 1 | steering system |
| 2 | motor |
| 3 | shaft |
| 4 | bearing |
| 5 | belt pulley |
| 6 | recirculating ball drive |
| 7 | belt pulley |
| 8 | shaft |
| 9 | timing belt |
| 10 | external toothing |
| 11 | external toothing |
| 12 | outer ring |
| 13 | inner ring |
| 14 | intermediate ring |
| 15 | flange |
| 16 | end face |
| 17 | edge |
| 18 | edge |
| 19 | face |
| 20 | end face |
| 21 | end face |
| 22 | edge |
| 23 | edge |
| 24 | face |
| 25 | end face |
| 26 | end face |
| 27 | curvature |
| 28 | curvature |
| 29 | curvature |
| 30 | curvature |
| 31 | recess |
| 32 | recess |
| 33 | recess |
| 34 | recess |
| 35 | recess |
| 36 | recess |
| 37 | projection |
| 38 | stepping |
| 39 | stepping |
| 40 | bearing seating surface |
| 41 | bearing |
| 42 | contact surface |
| 43 | radial projection |

1. A steering system (1) comprising a motor (2) with a first belt pulley (5) and a recirculating ball drive (6) with a second belt pulley (7), wherein the first and the second belt pulleys (5, 7) are connected to one another via a belt, preferably a timing belt (9), wherein the first and/or the second belt pulley (5, 7) comprise(s) an outer ring (12), an inner ring (13) and an intermediate ring (14), wherein the outer ring (12) preferably comprises an external toothing (1), the intermediate ring (14) is arranged between the outer ring (12) and the inner ring (13) in radial direction and connected to these, and the intermediate ring (14) at least partially comprises a rubbery-elastic material.

2. The steering system (1) according to claim 1, wherein the intermediate ring (14) is arranged in radial direction between a bearing seating surface (40) and a contact surface (42) of the second belt pulley (7) on a recirculating ball drive nut.

3. The steering system (1) according to claim 1, wherein edges (17, 18) of the inner ring (13) in the connection area between the inner ring (13) and the intermediate ring (14) and/or edges (22, 23) in the connection area between the outer ring (12) and the intermediate ring (14) are provided with a curvature (27 to 30).

4. The steering system (1) according to claim 1, wherein the intermediate ring (14) extends to protrude from the inner ring (13) and/or the outer ring (12) in axial direction and to partially cover the inner ring (13) and/or the outer ring (12) in radial direction.

5. The steering system (1) according to claim 1, wherein the inner ring (13) comprises at least one recess (33, 34) on at least one axial end face (20, 21) and/or the outer ring (12) comprises a recess (35, 36) on at least one axial end face (25, 26) and wherein the intermediate ring (14) engages with the recess (33 or 34 or 35 or 36) or with the recesses (33 to 36).

6. The steering system (1) according to claim 5, wherein edges of the recesses (33 to 36) in the axial end faces (20, 21, 25, 26) are also provided with curvatures.

7. The steering system (1) according to claim 1, wherein the inner ring (13) comprises a recess (31) on at least one radial face (19) and/or the outer ring (12) comprises a recess (32) on at least one radial face (24) and in that the intermediate ring (14) engages with the recess (31 or 32) or with the recesses (31, 32).

8. The steering system (1) according to claim 7, wherein edges of the recesses (31, 32) in the radial faces (19, 24) are also provided with curvatures.

9. The steering system (1) according to claim 1, wherein the intermediate ring (14) is vulcanized onto the inner ring (13) and/or the outer ring (12) or grouted with the inner ring (13) and/or the outer ring (12).
